(19) United States
(12) Patent Application Publication
(10) Pub. No.: US 2020/0246789 A1
(43) Pub. Date: Aug. 6, 2020

(54) CAPILLARY AND PIPETTE USING SAME

(71) Applicant: KYOCERA Corporation, Kyoto-shi, Kyoto (JP)

(72) Inventors: Yasushi YAMAGUCHI, Aira-city (JP); Yuji KOJIMA, Iwakuni-city (JP)

(21) Appl. No.: 16/496,617

(22) PCT Filed: Mar. 23, 2018
(86) PCT No.: PCT/JP2018/011785

§ 371 Date: Sep. 23, 2019

(30) Foreign Application Priority Data
Mar. 29, 2017 (JP) 2017-065423

(51) Int. Cl. B01L 3/02; G01N 1/14; G01N 35/10

(52) U.S. Cl. CPC B01L 3/0227; G01N 1/14; G01N 35/10; B01L 2300/06; B01L 2400/06; B01L 2300/12; B01L 2400/0487

(57) ABSTRACT

A capillary of the present disclosure has a tubular shape, both ends of which are a first end and a second end in a length direction and are open, an inner surface of which has water repellency and has a portion where a degree of the water repellency changes. A pipette of the present disclosure includes the capillary and a pipette main body to which the capillary 10 is attached, and the pipette main body has a pressure chamber that is deformable and connected to the capillary.

### TECHNICAL FIELD

The present disclosure relates to a capillary and a pipette using the same.

### BACKGROUND ART

In the related art, a pipette is known in which a plurality of types of liquids is agitated and mixed by reciprocating in a length direction of a probe after being sucked into a probe (see, for example, PTL 1 and PTL 2).

### CITATION LIST

### Patent Literature

PTL 1: Japanese Unexamined Patent Application Publication No. 10-62437

PTL 2: Japanese Unexamined Patent Application Publication No. 2000-304754

### SUMMARY OF INVENTION

A capillary of the present disclosure has a tubular shape. The capillary includes a first end and a second end in a length direction, and an inner surface. The first end and the second end are open. The inner surface has water repellency. A degree of the water repellency changes within at least a portion of the inner surface.

The pipette according to the present disclosure includes the capillary and a pipette main body. The pipette main body includes a deformable pressure chamber that is connected to the capillary.

### BRIEF DESCRIPTION OF DRAWINGS

FIG. 1 is a sectional view schematically illustrating an example of a configuration of a capillary according to the present disclosure.

FIG. 2 is a plan view schematically illustrating a first example of a configuration of a pipette of the present disclosure.

FIG. 3 is a sectional view taken along line A-A in FIG. 2.

FIG. 4 is a sectional view schematically illustrating a second example of the configuration of the pipette of the present disclosure.

FIG. 5 is a graph schematically illustrating an example of a change in voltage in a signal output from a first controller.

### DESCRIPTION OF EMBODIMENTS

In the above-described pipette of the related art, it is necessary to make a shape inside a probe complicated in order to stir liquids in the probe well and mix the liquids uniformly. Therefore, there is a problem that processing was difficult and it is difficult to produce a small probe capable of mixing a trace amount of liquids.

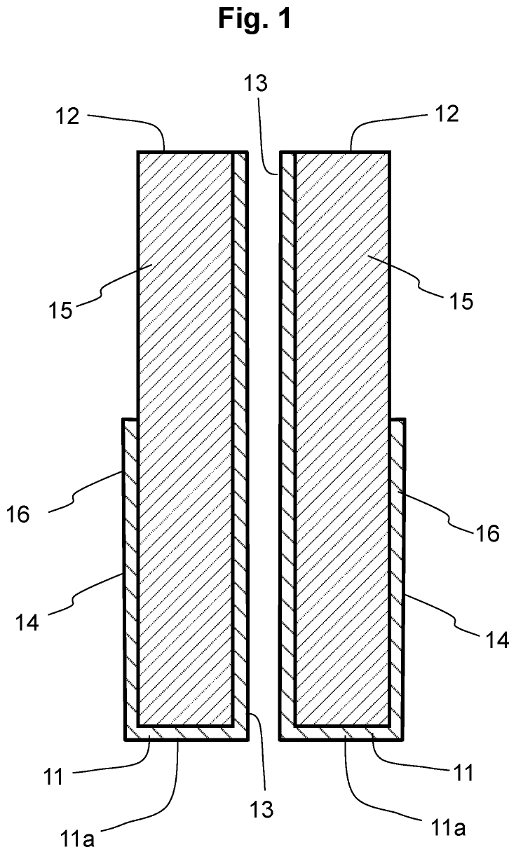

The capillary of the present disclosure can reduce such a problem. Hereinafter, the capillary of the present disclosure is described with reference to the drawings. FIG. 1 is a sectional view schematically illustrating an example of a configuration of the capillary of the present disclosure.

The capillary of the present disclosure has a tubular shape in which a first end 11 and a second end 12, which are both ends in a length direction, are open, and an inner surface 13 of the capillary has water repellency and has a portion where a degree of the water repellency changes. This configuration is a basic configuration of the capillary of the present disclosure. The capillary of the present disclosure may simply have such basic configuration, and other configurations are not essential and can be modified as appropriate. With the basic configuration, it is possible to obtain a capillary having high performance with a simple structure, which is good in performance when the liquid in the capillary is caused to reciprocate in a length direction of the capillary and is agitated.

That is, first, since the inner surface 13 of the capillary has the water repellency, even in a thin capillary in which a movement of a liquid by a capillary phenomenon is likely to occur, an unintentional movement of the liquid in a tube by the capillary phenomenon can be reduced. Therefore, the liquid in the capillary can be reciprocated as desired.

Second, since a portion, in which a degree of the water repellency of the inner surface 13 changes, is provided, when the liquid in the capillary moves in the length direction of the capillary, a force having a component in a direction parallel to a cross section of the capillary acts on the liquid moving in a portion in contact with the inner surface 13 of the capillary. Therefore, the liquid moves in a direction parallel to the cross section of the capillary, and the liquid is thus easily stirred. Accordingly, the liquid in the capillary can be well stirred by the reciprocation in the length direction of the capillary.

As described above, since the capillary of the present disclosure has a simple structure, the capillary can be miniaturized so that a small amount of liquids can be mixed and the capillary is good in performance when the liquids in the capillary are agitated by the reciprocation of the liquids in the length direction of the capillary.

In the present disclosure, the “tubular shape” means a shape that is long in one direction, is hollow, and is open at both ends, and does not mean only a cylindrical shape. In the present disclosure, the “degree of the water repellency changes” means that the degree of the water repellency changes in accordance with a change in position. A ratio of a change in the degree of the water repellency with respect to the change in position does not have to be constant, and may be partially increased or decreased, or may be partially zero. A direction in which the degree of the water repellency changes does not have to be constant. The degree of the water repellency may simply be continuously changed with respect to the continuous change in position.

Hereinafter, an example of the configuration of the capillary of the present disclosure is described in detail. The capillary of the example has the tubular shape in which the first end 11 and the second end 12, which are both ends in the length direction, are open. The capillary of the example has a capillary main body 15 and a water repellent film 16 on a surface of the capillary main body 15.

The capillary main body 15 has a tubular shape in which both ends in the length direction are open. The capillary main body 15 can be formed by using various known materials such as glass, resin, ceramics, or metal. It is preferable that the capillary main body 15 be transparent so that the liquid inside is visible, and for example, glass can be suitably used. A shape of the capillary main body 15 may simply be a tubular shape, and various shapes can be selected. However, in terms of ease of manufacturing, the capillary main body 15 is preferably a cylindrical shape. An inner diameter of the capillary main body 15 can be appropriately set in accordance with an amount of the liquid to be sucked and stirred, and can be set to approximately 0.1 mm to 0.3 mm, for example. A length of the capillary main body 15 can be appropriately set in accordance with an amount of the liquid to be sucked and stirred and in accordance with the shape of the pipette to which the capillary is attached, and is set to approximately 20 mm to 100 mm, for example.

The water repellent film 16 is provided over an entire inner surface of the capillary main body 15, and is also provided on one end surface in the length direction of the capillary main body 15 and on part of an outer surface of the capillary main body 15. That is, the entire inner surface 13 of the capillary, the outer surface 14 adjacent to the first end 11 of the capillary main body 15, and an end surface 11a of the first end 11 of the capillary main body 15 are covered with the water repellent film 16. Therefore, the entire inner surface 13 of the capillary, the outer surface 14 adjacent to the first end 11 of the capillary main body 15, and the end surface 11a of the first end 11 of the capillary main body 15 have the water repellency.

As the water repellent film 16, for example, various water repellent films such as a water repellent film of a silane coupling agent, a metal alkoxide-containing water repellent film, a silicone-containing water repellent film, or a fluorine-containing water repellent film can be used. As a method for forming the water repellent film 16 on the surface of the capillary main body 15, various methods can be used. Examples of a dry process method include a physical vapor phase growth method such as a physical vapor deposition method and a sputtering method, and a chemical vapor growth method such as a chemical vapor deposition method (CVD) and an atomic layer deposition method (ALD). Examples of a wet process method include a sol-gel method, a dip coating method, a coating method, and the like.

The capillary of the example has a configuration in which the water repellent film 16 on the inner surface 13 has a surface density of the water repellent substance increasing from the second end 12 toward the first end 11. Therefore, in the capillary of the example, the degree of the water repellency on the inner surface 13 changes so that the water repellency increases from the second end 12 toward the first end 11. Since there is a positive correlation between the degree of the water repellency and the surface density of the water-repellent substance, the degrees of the water repellency can be compared by measuring and comparing intensities of water-repellent substance-derived ions (for example, when a fluorine-based water repellent film is used, fluorine-containing ions such as C₂F₅⁺), for example, by using time-of-flight secondary ion mass spectrometry (TOF-SIMS).

For example, such water repellent film 16 can be formed as follows. First, the capillary main body 15 is held with the first end 11 facing down, and a water repellent (for example, a fluorine-based water repellent) is injected into the capillary main body 15 from the first end 11, and then is discharged from the first end 11. Next, the capillary main body 15 is held so that the first end 11 faces down, a portion adjacent to the first end 11 is immersed in a pool of the water repellent, held for a certain time, and then pulled up. The water repellent liquid remaining in the tube is discharged from the first end 11. Next, the capillary main body 15 is held so that the first end 11 faces down, and is left at room temperature for a certain time (for example, approximately 2 hours). Next, in a state in which the capillary main body 15 is held so that the first end 11 faces down, the capillary main body 15 is held at a high temperature (for example, approximately 100° C.) and left for a certain time (for example, approximately 1 hour). In this way, the water repellent film 16 can be formed in the capillary of the example.

As described above, in the capillary of the example, the inner surface 13 has a portion in which the degree of the water repellency changes in the length direction. With such a configuration, the liquid can be efficiently stirred by reciprocating the liquid in the capillary in the length direction of the capillary. The degree of the water repellency does not necessarily change in the length direction, and for example, the degree of the water repellency may change in a direction parallel to the cross section of the capillary. The water repellency may be changed over the entire inner surface 13 of the capillary, but a portion in which the water repellency changes may be part of the inner surface 13.

In the capillary of the example, the water repellency on the inner surface 13 increases from the center in the length direction toward the first end 11. With such a configuration, when the liquid in the capillary is reciprocated in the length direction of the capillary near the first end 11 and stirred, the liquid in the capillary is unlikely to flow out from the first end 11.

In the capillary of the example, the end surface 11a of the first end 11 and a portion of the outer surface 14 adjacent to the end surface 11a of the first end 11 have the water repellency. With such a configuration, when the liquid is sucked from the first end 11, a liquid pool is unlikely to be formed on the end surface 11a of the first end 11 and the portion of the outer surface 14 adjacent to the end surface 11a. Therefore, a suction amount of the liquid becomes accurate, and mixing of liquids when sucking a plurality of liquids can be reduced.

In the capillary of the example, the degree of the water repellency of the end surface 11a of the first end 11 may be higher than the degree of the water repellency of the inner surface 13 adjacent to the end surface 11a of the first end 11. With such a configuration, the liquid pool is further unlikely to be formed on the end surface 11a when the liquid is sucked from the first end 11.

In the example, although the entire inner surface 13 of the capillary, the outer surface 14 adjacent to the first end 11 of the capillary main body 15, and the end surface 11a of the first end 11 of the capillary main body 15 have the water repellency, the present disclosure is not limited thereto. For example, the end surface of the second end 12 and the outer surface 14 adjacent to the second end 12 of the capillary main body 15, the water repellent film 16 may also be covered with the water repellent film 16 and the entire capillary 10 may have the water repellency. If the length of the capillary 10 is sufficiently long and the liquid does not reach the second end 12 of the capillary 10, a portion of the inner surface 13, which does not come into contact with the liquid, adjacent to the second end 12 may not have the water repellency. That is, the portion of the inner surface 13, which comes into contact with the liquid, may simply have the water repellency.

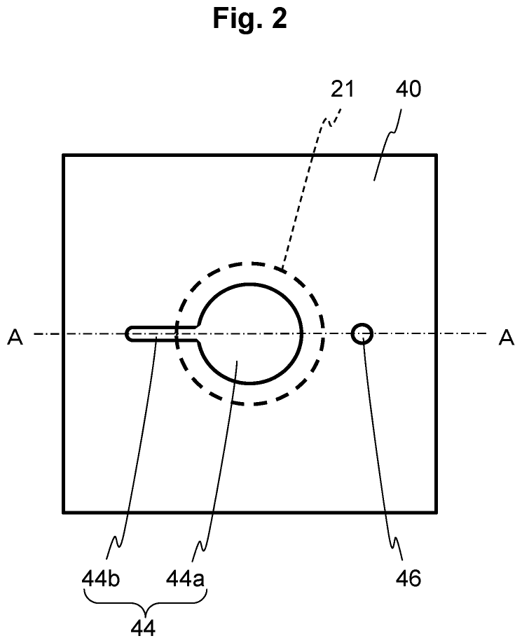

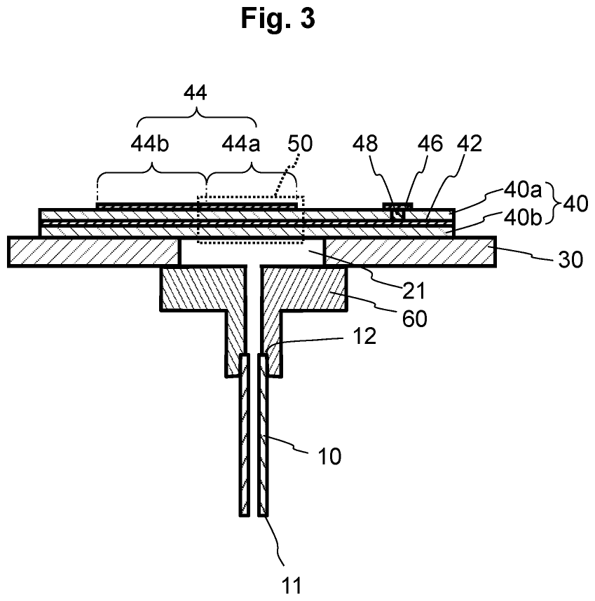

Next, the pipette of the present disclosure is described with reference to FIGS. 2 to 5. FIG. 2 is a plan view schematically illustrating a first example of the configuration of the pipette of the present disclosure. FIG. 3 is a sectional view which is taken along line A-A of FIG. 2. The pipette of the example includes the capillary 10 and a pipette main body 20 to which the capillary 10 is attached, and the pipette main body 20 has a pressure chamber 21 that is deformable and connected to the capillary 10. The capillary 10 is the capillary of the present disclosure described above. The configuration is the basic configuration of the pipette of the present disclosure. The pipette of the present disclosure may simply have the basic configuration, and the other configurations are not essential and can be modified as appropriate. With the basic configuration, the liquid in the capillary 10 can be reciprocated in the length direction of the capillary 10 by deforming the pressure chamber 21 so that a volume of the pressure chamber 21 periodically changes, and thereby the liquids in the capillary 10 can be stirred and mixed.

Hereinafter, a first example of the configuration of the pipette of the present disclosure is described in detail. The pipette of the example has a capillary 10 and a pipette main body 20 to which the capillary 10 is attached. The capillary 10 is the capillary illustrated in FIG. 1, and detailed description thereof is omitted. The capillary 10 is attached to the pipette main body 20 at a portion adjacent to the second end 12.

The pipette main body 20 is formed by sequentially stacking a piezoelectric substrate 40, a first member 30, and a second member 60, and the capillary 10 is connected to the second member 60. The pipette main body 20 includes a pressure chamber 21 and an air passage 22 which connects the pressure chamber 21 and the capillary 10 so that air flows between the pressure chamber 21 and the capillary 10.

The first member 30 is a member which constitutes a side wall of the pressure chamber 21, and can be constituted by using various materials, such as a metal, ceramic, or resin. For example, the first member 30 has a plate shape with a thickness of approximately 50 μm to 5 mm, and a through-hole to be the pressure chamber 21 is formed at a center of the first member 30. A shape and a size of the through-hole can be selected as appropriate, and can be, for example, a circular shape having a diameter of approximately 2 to 50 mm. A piezoelectric substrate 40 is stacked and bonded to an upper surface of the first member 30 so as to close the through-hole to be the pressure chamber 21, and part of the piezoelectric substrate 40 constitutes an upper wall of the pressure chamber 21.

The second member 60 is stacked and bonded to a lower surface of the first member 30 so as to close the through-hole to be the pressure chamber 21, and part of the second member 60 constitutes a lower wall of the pressure chamber 21. The second member 60 includes the air passage 22 extending in a top-bottom direction, and an upper end of the air passage 22 is connected to the pressure chamber 21. The capillary 10 is attached to the lower surface of the second member 60 so as to be connected to a lower end of the air passage 22, and the capillary 10 and the pressure chamber 21 are connected via the air passage 22 so that air flows between the pressure chamber 21 and the capillary 10. A shape and a size of the air passage 22 can be set as appropriate, and for example, the air passage 22 can be a circular tube having a diameter of approximately 0.1 mm to 1 mm. The second member 60 can be formed by using various materials such as metal, ceramic, or resin.

The piezoelectric substrate 40 has a flat plate shape with a size of approximately 3 mm to 100 mm and a thickness of approximately 20 μm to 2 mm, and has two stacked piezoelectric ceramic layers 40a and 40b. The thickness of the piezoelectric ceramic layers 40a and 40b can be, for example, approximately 10 μm to 30 μm. The piezoelectric ceramic layers 40a and 40b can be formed by using various piezoelectric materials. For example, ceramic materials such as lead zirconate titanate (PZT)-based, NaNbO₃-based, KNaNbO3-based, BaTiO₃-based, (BiNa)NbO₃-based, or BiNaNb₅O₁₅-based ceramic materials having ferroelectricity can be preferably used. The piezoelectric ceramic layer 40a is polarized in the thickness direction and, when a voltage is applied, expands and contracts in the horizontal direction. However, since no voltage is applied to the piezoelectric ceramic layer 40b, a material other than the piezoelectric material may be used.

The piezoelectric substrate 40 includes an internal electrode 42, a surface electrode 44, a connection electrode 46, and a through electrode 48. These electrodes and conductors can be formed by using various metal materials. For example, a metal material such as Ag—Pd can be suitably used for the internal electrode 42 and the through electrode 48, and, for example, a metal material such as Au can be suitably used for the surface electrode 44 and the connection electrode 46.

The internal electrode 42 is disposed between the piezoelectric ceramic layer 40a and the piezoelectric ceramic layer 40b, and has substantially the same size as the piezoelectric substrate 40. A thickness of the internal electrode 42 can be approximately 2 μm, for example.

The surface electrode 44 includes a surface electrode main body 44a and an extraction electrode 44b, and is provided on the surface of the piezoelectric substrate 40. The surface electrode main body 44a has a planar shape substantially the same as the pressure chamber 21, and is provided so as to overlap the pressure chamber 21 in the thickness direction. The extraction electrode 44b is formed so as to be extracted from the surface electrode main body 44a. The thickness of the surface electrode 44 can be approximately 1 μm, for example.

The connection electrode 46 is provided on the surface of the piezoelectric substrate 40 and is connected to the internal electrode 42 via the through electrode 48 that penetrates the piezoelectric ceramic layer 40a.

Part of the piezoelectric ceramic layer 40a is held between the surface electrode main body 44a and the internal electrode 42. A driving unit 50 that deforms with the application of a voltage is formed by the surface electrode main body 44a and a portion of the internal electrode 42 and the piezoelectric ceramic layers 40a and 40b which overlaps the surface electrode main body 44a in the thickness direction. As described above, the driving unit 50 is formed by using the piezoelectric material.

By applying a voltage between the extraction electrode 44b and the connection electrode 46, a portion of the piezoelectric ceramic layer 40a held between the surface electrode main body 44a and the internal electrode 42 expands or contracts in the horizontal direction, and since the piezoelectric ceramic layer 40b is not deformed, the driving unit 50 bends. When the driving unit 50 bends, the volume of the pressure chamber 21 changes, and the pressure in the capillary 10 connected through the air passage 22 changes. Therefore, the suction of the liquid into the capillary 10 and the movement of the liquid in the capillary 10 can be performed.

In the capillary 10 of the example, the second end 12 of the capillary 10 is attached to the pipette main body 20. With such a configuration, all the effects of the capillary 10 described above can be obtained, and a pipette having high performance can be thus obtained.

FIGS. 2 and 3 illustrate an example in which the volume of the pressure chamber 21 changes due to the deformation of the driving unit 50 formed by using the piezoelectric material, but the present disclosure is not limited thereto. For example, the pressure chamber 21 may be made of rubber or the like having appropriate elasticity, and the pressure chamber 21 may be manually deformed to change the volume of the pressure chamber 21.

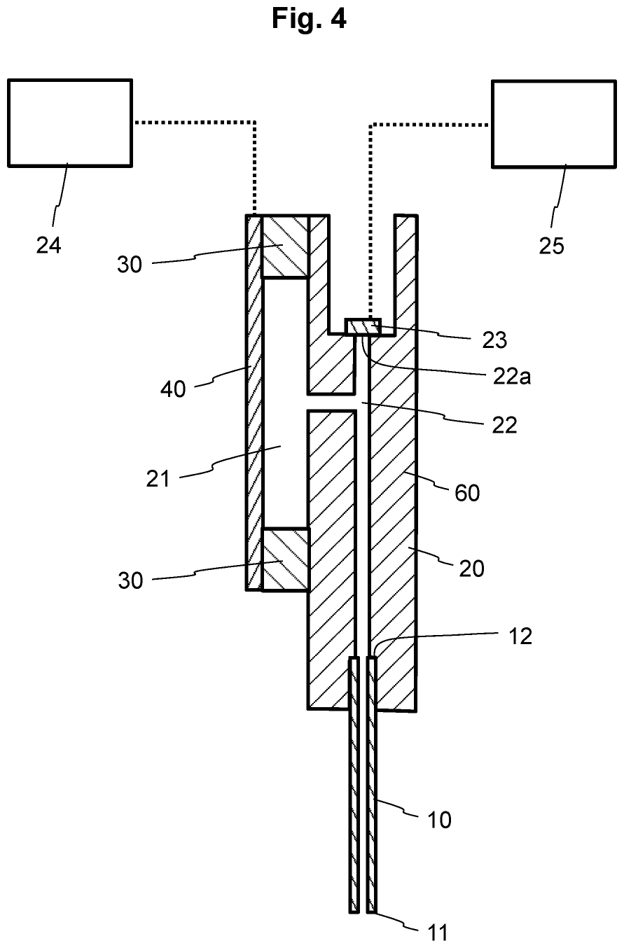

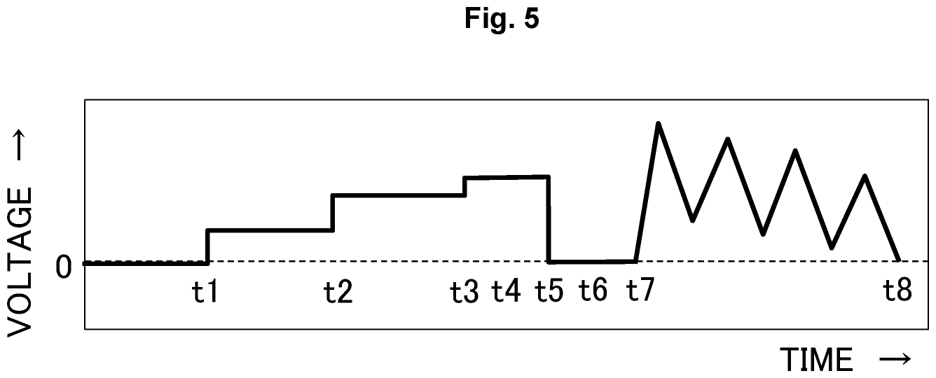

Next, a second example of the configuration of the pipette according to the present disclosure is described with reference to FIGS. 4 and 5. FIG. 4 is a sectional view schematically illustrating the second example of the configuration of the pipette of the present disclosure. In the example, different portions from those of the first example described above are described, and the same constituent elements are denoted by the same reference characters and redundant description is omitted. The pipette of the example is different from that of the first example in shapes of the air passage 22 and the second member 60. The pipette of the example includes a valve 23, a first controller 24, and a second controller 25.

The air passage 22 in the example connects the capillary 10 and the pressure chamber 21, and includes an opening 22a opened to the outside of the pipette. The opening 22a is provided with the valve 23 that opens/closes the air passage 22 to/from the outside of the pipette.

The valve 23 is electrically connected to the second controller 25 and performs an opening/closing operation in accordance with a signal from the second controller 25. Specifically, when a third signal is input from the second controller 25, the valve 23 is opened, and when a fourth signal is input from the second controller 25, the valve 23 is closed. As the valve 23, various valves such as an electromagnetic valve, a piezoelectric valve, or an electric valve can be used.

The first controller 24 is electrically connected to the driving unit 50, and outputs a first signal that drives the driving unit 50 so that the volume of the pressure chamber 21 increases, a second signal that drives the driving unit 50 so that the volume of the pressure chamber 21 periodically changes, and a fifth signal that drives the driving unit 50 so that the volume of the pressure chamber 21 decreases.

The first controller 24 and the second controller 25 can be formed by using various integrated circuits. The first controller 24 and the second controller 25 may be or may not be provided in the pipette main body 20. For example, the first controller 24 and the second controller 25 may be provided in a separate controller from the pipette main body 20, and the pipette main body 20 and the controller may be connected by a cable.

Next, an example of an operation of the pipette of the example is described with reference to FIG. 5. FIG. 5 is a graph schematically illustrating an example of a change in voltage in a signal output from the first controller. In FIG. 5, a horizontal axis indicates time, and a vertical axis indicates voltage.

First, the first end 11 of the capillary 10 is immersed in a liquid A, the first controller 24 outputs the first signal that drives the driving unit 50 so that the volume of the pressure chamber 21 increases at time t1, and a predetermined voltage is applied to the piezoelectric ceramic layers 40a of the driving unit 50. As a result, the volume of the pressure chamber 21 increases and the liquid A is sucked into the capillary 10.

Next, the first end 11 of the capillary 10 is immersed in a liquid B, the first controller 24 outputs the first signal again at time t2, and a higher voltage is applied to the piezoelectric ceramic layer 40a of the driving unit 50. As a result, the volume of the pressure chamber 21 further increases, and the liquid B is sucked into the capillary 10.

Next, the first end 11 of the capillary 10 is pulled out from the liquid B into the air, the first controller 24 outputs the first signal again at time t3, and a higher voltage is applied to the piezoelectric ceramic layer 40a of the driving unit 50. Therefore, the volume of the pressure chamber 21 further increases, and the liquid A and the liquid B move toward the second end 12 in the capillary 10. Accordingly, when the liquid A and the liquid B are subsequently reciprocated in the length direction of the capillary 10 and stirred, the liquids can be prevented from leaking to the outside of the capillary 10.

Next, at time t4, the second controller 25 outputs a third signal for opening the valve 23, whereby the valve 23 is opened, the outside of the pipette is connected to the pressure chamber 21, and the pressure in the pressure chamber 21 becomes equal to the atmospheric pressure. At this time, positions of the liquid A and the liquid B do not change.

Next, at time t5, the first controller 24 outputs the fifth signal that drives the driving unit 50 so that the volume of the pressure chamber 21 decreases, and the voltage applied to the piezoelectric ceramic layer 40a of the driving unit 50 becomes zero. Therefore, the volume of the pressure chamber 21 decreases, but the positions of the liquid A and the liquid B do not change, because the pressure chamber 21 is being connected to the outside.

Next, at time t6, the second controller 25 outputs a fourth signal to close the valve 23, whereby the valve 23 is closed and the pressure chamber 21 is closed to the outside. The positions of the liquid A and the liquid B do not change.

Next, during time t6 to t8, the first controller 24 outputs the second signal that drives the driving unit 50 so that the volume of the pressure chamber 21 periodically changes. As a result, the liquid A and the liquid B are reciprocated in the length direction of the capillary 10 and agitated, and the liquid A and the liquid B are mixed.

FIG. 5 illustrates an example in which a positive voltage is applied to the driving unit 50. For example, a negative voltage may be applied to the driving unit 50 by reversing a direction of the polarization of the piezoelectric ceramic layer 40a.

As described above, the pipette of the example includes the driving unit 50 that deforms the pressure chamber 21, and the first controller 24 that controls the driving unit 50. The first controller 24 outputs the first signal that drives the driving unit 50 so that the volume of the pressure chamber 21 increases and the second signal that drives the driving unit 50 so that the volume of the pressure chamber 21 periodically changes. With such a configuration, the liquids can be sucked and mixed by a simple operation.

In the pipette of the example, the driving unit 50 is configured by using the piezoelectric material, and the second signal is a signal where the magnitude of voltage periodically changes and an absolute value of the average value of the voltages of one cycle decreases with lapse of time. Such configuration enables a problem that, when the liquid in the capillary 10 is reciprocated in the length direction of the capillary 10 and stirred, the liquid in the capillary 10 gradually moves toward the second end 12 of the capillary 10, to be prevented. The inventors have discovered the problem, and a cause of the problem has not yet been specified, but it has been confirmed by the inventors that the problem occurs even when the driving unit 50 that does not use the piezoelectric material is used. The problem can be solved by the pipette of the example.

The pipette of the example includes the valve 23 that is openable and closable and that connects the outside and the pressure chamber 21. Such configuration enables, for example, by repeatedly sucking the liquid and opening and closing the valve 23, the liquid having a volume exceeding an amount of increase in volume of the pressure chamber 21 by the driving of the driving unit 50, to be sucked.

The pipette of the example includes the second controller 25 that controls the valve 23, and before the first controller 24 outputs the second signal, the third signal that opens the valve 23 and the fourth signal that closes the valve 23 are sequentially output from the second controller 25. The fifth signal that drives the driving unit 50 is output from the first controller 24 until the fourth signal is output after the third signal is output, so that the volume of the pressure chamber 21 decreases. Such configuration can prevent, for example, a reciprocating distance when the liquid in the capillary 10 is reciprocated from decreasing due to a limit of a deformation amount of the driving unit 50. In addition, a magnitude of the voltage applied to the driving unit 50 can be reduced.

### REFERENCE SIGNS LIST

10 capillary
11 first end
11a end surface
12 second end
13 inner surface
14 outer surface
15 capillary main body
16 water repellent film
20 pipette main body
21 pressure chamber
22 air passage
23 valve
24 first controller
25 second controller
30 first member
40 piezoelectric substrate
50 driving unit
60 second member

1. A capillary in a tubular shape, the capillary comprising:
a first end and a second end in a length direction, both ends being open; and
an inner surface that is water repellent, wherein a degree of the water repellency changes within at least a portion of the inner surface.

2. The capillary according to claim 1, wherein the degree of the water repellency changes along the length direction of the inner surface.

3. The capillary according to claim 2, wherein
the degree of water repellency increases from a center of the inner surface in the length direction toward the first end.

4. The capillary according to claim 1, wherein further comprising:
an end surface of the first end; and
a portion of an outer surface adjacent to the end surface; wherein both the end surface and the portion of the outer surface are water repellant.

5. The capillary according to claim 4, wherein
the end surface has a higher degree of water repellency than a portion of the inner surface adjacent to the end surface.

6. A pipette comprising:
the capillary according to claim 1; and
a pipette main body, the pipette main body including a deformable pressure chamber that is connected to the capillary.

7. The pipette according to claim 6, wherein
the second end of the capillary is attached to the pipette main body.

8. The pipette according to claim 6, further comprising:
a driving unit that causes the pressure chamber to be deformed; and
a first controller, the first controller configured to
output a first signal to drive the driving unit so that a volume of the pressure chamber increases, and
output a second signal to drive the driving unit so that the volume of the pressure chamber periodically changes.

9. The pipette according to claim 8, wherein
the driving unit comprises a piezoelectric material, and
the second signal is a signal in which a magnitude of a voltage periodically changes and an absolute value of an average value of voltages in one cycle decreases with a lapse of time.

10. The pipette according to claim 8, further comprising:
a valve that connects an outside and the pressure chamber, wherein the valve can be opened or closed.

11. The pipette according to claim 10, further comprising:
a second controller that controls the valve, wherein the second controller is configured to sequentially output a third signal to open the valve and a fourth signal to close the valve prior to the second signal; and
the first controller is further configured to output a fifth signal to drive the driving unit so that the volume of the pressure chamber decreases until the fourth signal is output after the third signal is output.
